(19) United States
(12) Patent Application Publication
(10) Pub. No.: US 2025/0013335 A1
(43) Pub. Date: Jan. 9, 2025

(54) TOUCH SENSOR AND TOUCH PANEL

(71) Applicant: FUJIFILM Corporation, Tokyo (JP)

(72) Inventor: Tokuju OIKAWA, Kanagawa (JP)

(73) Assignee: FUJIFILM Corporation, Tokyo (JP)

(21) Appl. No.: 18/752,046

(22) Filed: Jun. 24, 2024

(30) Foreign Application Priority Data
Jun. 28, 2023 (JP) 2023-105846

(51) Int. Cl. G06F 3/044

(52) U.S. Cl. CPC G06F 3/0446; G06F 2203/04112

(57) ABSTRACT

A touch sensor in which it is possible to suppress a decrease in conductivity of peripheral wirings and the occurrence of migration between the peripheral wirings, and a touch panel having the touch sensor. The touch sensor includes: a substrate; and a conductive layer formed on a surface of the substrate, the conductive layer has a touch detection electrode composed of a plurality of fine metal wires disposed in a mesh shape, an electrode connection terminal electrically connected to the touch detection electrode, and a peripheral wiring electrically connected to the electrode connection terminal, the peripheral wiring has a to-be-plated layer and a metal plating layer covering the to-be-plated layer, and the surface of the substrate has a water contact angle of 20° to 50°.

### CROSS-REFERENCE TO RELATED APPLICATIONS

The present application claims priority under 35 U.S.C. § 119 to Japanese Patent Application No. 2023-105846 filed on Jun. 28, 2023. The above application is hereby expressly incorporated by reference, in its entirety, into the present application.

### BACKGROUND OF THE INVENTION

### 1. Field of the Invention

The present invention relates to a touch sensor that detects a touch operation and a touch panel.

### 2. Description of the Related Art

In the related art, in various electronic apparatuses including portable information apparatuses such as a tablet-type computer and a smartphone, a touch sensor that detects a so-called touch operation of allowing a finger, a stylus pen, or the like to contact or approach a screen has been used. Such a touch sensor usually has touch detection electrodes that are formed on a surface of a substrate and detect a touch operation, external connection terminals that are formed on the surface of the substrate and used to electrically connect the touch sensor to an external apparatus, and peripheral wirings that electrically connect the touch detection electrodes and the external connection terminals.

For example, JP2023-066192A discloses a method of producing a conductive substrate having a to-be-plated layer and a plating layer by using a laminate having, in this order, a substrate, an underlayer, and a precursor layer of a to-be-plated layer disposed in contact with the underlayer. JP2023-066192A also describes that the plating layer functions as a detection electrode or a lead wiring in a case where the conductive substrate is applied to a touch panel sensor.

### SUMMARY OF THE INVENTION

In recent years, in touch sensors, so-called frame narrowing has been attempted in which a region outside a region where detection electrodes are disposed is narrowed. The present inventors have conducted an investigation on the frame narrowing of a touch sensor with reference to the technique disclosed in JP2023-066192A, and found that, in a touch sensor with a narrower frame, a decrease in conductivity of peripheral wirings such as an increase in resistivity, or migration between the peripheral wirings is more likely to occur.

In consideration of the above circumstances, an object of the present invention is to provide a touch sensor in which it is possible to suppress a decrease in conductivity of peripheral wirings and the occurrence of migration between the peripheral wirings. Another object of the present invention is to provide a touch panel having the touch sensor.

The present inventors have conducted a thorough investigation to achieve the objects, thereby completing the present invention. That is, the present inventors have found that the objects are achieved by the following configuration.

[1] A touch sensor comprising: a substrate; and a conductive layer formed on a surface of the substrate, in which the conductive layer has a touch detection electrode composed of a plurality of fine metal wires disposed in a mesh shape, an electrode connection terminal electrically connected to the touch detection electrode, and a peripheral wiring electrically connected to the electrode connection terminal, the peripheral wiring has a to-be-plated layer and a metal plating layer covering the to-be-plated layer, and the surface of the substrate has a water contact angle of 20° to 50°.

[2] The touch sensor according to [1], in which the substrate contains a surfactant.

[3] The touch sensor according to [2], in which the surfactant is a nonionic surfactant.

[4] The touch sensor according to [3], in which the surface of the substrate has a water contact angle of 20° to 40°.

[5] The touch sensor according to [1], in which a plurality of the peripheral wirings are present, and in at least a part of a region where the peripheral wirings are disposed on the surface of the substrate, the peripheral wirings extend in a first direction, are arranged in a second direction perpendicular to the first direction, and a distance S between two peripheral wirings adjacent to each other is 30 μm or less.

[6] The touch sensor according to [5], in which a plurality of the peripheral wirings are present, and in at least a part of a region where the peripheral wirings are disposed on the surface of the substrate, the peripheral wirings extend in the first direction, are arranged in the second direction perpendicular to the first direction, and a distance S between two peripheral wirings adjacent to each other is 15 μm or less.

[7] A touch panel comprising the touch sensor according to any one of [1] to [6].

According to the present invention, it is possible to provide a touch sensor in which it is possible to suppress a decrease in conductivity of peripheral wirings and the occurrence of migration between the peripheral wirings. In addition, according to the present invention, it is possible to provide a touch panel having the touch sensor.

### BRIEF DESCRIPTION OF THE DRAWINGS

FIG. 1 is a plan view showing an example of a configuration of a touch sensor according to the present invention.

FIG. 2 is an enlarged plan view showing an example of a configuration of peripheral wirings of the touch sensor according to the present invention.

FIG. 3 is an enlarged plan view showing an example of a configuration of a touch detection electrode of the touch sensor according to the present invention.

### DESCRIPTION OF THE PREFERRED EMBODIMENTS

Hereinafter, a touch sensor and a touch panel according to an embodiment of the present invention will be described in detail with reference to the drawings.

The following configuration requirements will be described based on typical embodiments of the present invention in some cases, but the present invention is not limited to the embodiments. Further, the drawings shown below are exemplary drawings for describing the present invention, and the present invention is not limited to the drawings shown below.

In the present specification, numerical ranges represented by “to” include numerical values before and after “to” as lower limit values and upper limit values.

In the present specification, in a case where there are two or more components corresponding to a certain component, the “content” of such a component represents a total content of the two or more components.

Unless otherwise specified, angles represented by specific numerical values and expressions regarding angles such as “parallel”, “perpendicular”, and “orthogonal” include error ranges that are generally allowable in the corresponding technical field.

A “polymer” represents a compound having a weight-average molecular weight of 2,000 or more. Here, the weight-average molecular weight is defined as a polystyrene equivalent value measured by gel permeation chromatography (GPC) under the following conditions.
Device: HLC-8320GPC manufactured by Tosoh Corporation
Column: TSK-GEL G3000PWXL manufactured by Tosoh Corporation
Column Temperature: 35° C.
Flow Rate: 0.5 mL/min.
Calibration Curve: POLY SODIUM ACRYLATE STANDARD manufactured by Sowa Kagaku K.K.
Eluent: a solution prepared by diluting a mixture of sodium dihydrogen phosphate dodecahydrate/disodium hydrogen phosphate dihydrate (34.5 g/46.2 g) to 5,000 g with pure water

A “main surface” represents a surface having the largest area in a film-like, sheet-like, or plate-like member.

The term “transparent” represents that a light transmittance in a visible wavelength range of 400 to 800 nm is 40% or more, preferably 60% or more, more preferably 80% or more, and still more preferably 90% or more. The light transmittance is measured according to “Plastics-Determination of Total Luminous Transmittance and Reflectance” specified in JIS K 7375:2008 by using known transmittance measurement equipment.

### Touch Sensor

The touch sensor according to the embodiment of the present invention includes a substrate and a conductive layer formed on a surface of the substrate. The conductive layer has a touch detection electrode composed of a plurality of fine metal wires disposed in a mesh shape, an electrode connection terminal electrically connected to the touch detection electrode, and a peripheral wiring electrically connected to the electrode connection terminal, and the peripheral wiring has a to-be-plated layer and a metal plating layer covering the to-be-plated layer. In addition, the surface of the substrate of the touch sensor according to the embodiment of the present invention has a water contact angle of 20° to 50°.

Hereinafter, the touch sensor according to the embodiment of the present invention will be described in detail with reference to the drawings.

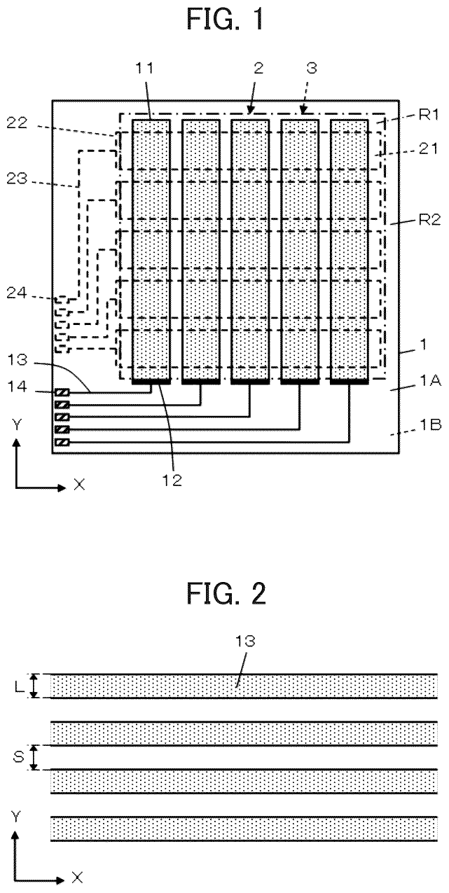

FIG. 1 is a plan view showing an example of a configuration of the touch sensor according to the embodiment of the present invention.

A touch sensor 10 includes a substrate 1, a first conductive layer 2 formed on one surface 1A of the substrate 1, and a second conductive layer 3 formed on another surface 1B of the substrate 1.

The first conductive layer 2 has a plurality of touch detection electrodes 11 that extend in a Y direction (first direction) and are arranged in an X direction (second direction) perpendicular to the Y direction, a plurality of electrode connection terminals 12 that are formed at one ends of the plurality of touch detection electrodes 11, respectively, a plurality of peripheral wirings 13 that are electrically connected to the plurality of electrode connection terminals 12, and a plurality of external connection terminals 14 that are electrically connected to the plurality of peripheral wirings 13. The plurality of external connection terminals 14 are used to be electrically connected to an external apparatus (not shown).

One end of each of the plurality of peripheral wirings 13 is connected to the corresponding electrode connection terminal 12, and the other end thereof is connected to the external connection terminal 14.

The second conductive layer 3 has a plurality of touch detection electrodes 21 that extend in the X direction (first direction) and are arranged in the Y direction (second direction), a plurality of electrode connection terminals 22 that are electrically connected to one ends of the plurality of touch detection electrodes 21, respectively, a plurality of peripheral wirings 23 that are electrically connected to the plurality of electrode connection terminals 22, and a plurality of external connection terminals 24 that are electrically connected to the plurality of peripheral wirings 23. The plurality of external connection terminals 24 are used to be electrically connected to an external apparatus (not shown).

One end of each of the plurality of peripheral wirings 23 is connected to the corresponding electrode connection terminal 22, and the other end thereof is connected to the external connection terminal 24.

As described below, the touch detection electrodes 11 and 21 function as sensor electrodes for detecting a so-called touch operation, and are composed of a plurality of fine metal wires.

In the touch sensor 10 shown in FIG. 1, a detection region R1 is a region surrounding the touch detection electrodes 11 and 21 disposed on the surfaces of the substrate 1. A peripheral region R2 is a region provided on the outer side (peripheral edge side) than the detection region R1, and the peripheral wirings 13 are disposed in the peripheral region R2.

FIG. 2 is an enlarged plan view showing an example of a configuration of the peripheral wirings in the peripheral region of the touch sensor. In FIG. 2, each of the plurality of peripheral wirings 13 extends in the X direction and is arranged in the Y direction perpendicular to the X direction. In addition, the plurality of peripheral wirings 13 have a line width L, and two peripheral wirings 13 adjacent to each other are disposed with an interval of a distance S therebetween.

Here, the above-described frame narrowing is an attempt to further enlarge the detection region R1 for detecting a touch operation and to further reduce the peripheral region R2 in the touch sensor 10. As a method of realizing the frame narrowing of the touch sensor, for example, it is conceivable to narrow at least one of the distance S between two adjacent peripheral wirings or the line width L of the peripheral wirings in the peripheral region R2 where the peripheral wirings 13 shown in FIG. 2 are arranged.

The present inventors have conducted an investigation on the configuration and arrangement of the peripheral wirings for frame narrowing of the touch sensor, and found that, in a region where the peripheral wirings are arranged, a decrease in conductivity such as an increase in resistivity, or migration between the peripheral wirings may occur, and particularly, in a region where the distance S is narrow, a decrease in conductivity and migration may be more likely to occur.

The touch sensor 10 according to the embodiment of the present invention includes a substrate 2 in which the water contact angle of the surface 2A is 20° to 50°. In a case where the water contact angle of the surface 2A of the substrate 2 is in the above range, it is possible to suppress a decrease in conductivity of the peripheral wirings and the occurrence of migration between the peripheral wirings in a region where the plurality of peripheral wirings are arranged, particularly in a region where the distance S is narrowed for frame narrowing. That is, in a case where the touch sensor according to the embodiment of the present invention has the above-described characteristics, a decrease in conductivity and the migration in the peripheral wirings are excellently suppressed.

Although the mechanism by which the touch sensor according to the embodiment of the present invention is excellent in performance of suppressing a decrease in conductivity and the migration in the peripheral wirings is not perfectly clear, the present inventors have assumed the following.

The peripheral wiring of the touch sensor according to the embodiment of the present invention is composed of a to-be-plated layer and a metal plating layer covering the to-be-plated layer. Here, in order to form the conductive layer, a to-be-plated layer is formed at a position corresponding to the peripheral wiring, and then the formed to-be-plated layer is subjected to a plating treatment to precipitate a metal on a surface of the to-be-plated layer and to thus form a metal plating layer. It is conceivable that, in the step of forming the conductive layer, air bubbles may adhere to the surface of the to-be-plated layer due to the reaction between a constituent material of the conductive layer such as a plating metal and a component in a plating treatment liquid. In this case, no metal is precipitated on the surface portion of the to-be-plated layer with air bubbles adhering thereto, and as a result, it is assumed that a part of the metal plating layer for the conductivity of the peripheral wiring is lost and the conductivity is decreased.

In the touch sensor according to the embodiment of the present invention, since the surface of the substrate has a water contact angle of 50° or less, air bubbles are difficult to adhere to the region where the substrate is exposed between the to-be-plated layers (particularly, the region where the to-be-plated layers corresponding to the peripheral wirings with a small distance S therebetween are formed). As a result, it is assumed that the plating treatment can be performed in a state in which no air bubbles remain on the surface of the to-be-plated layer, and a decrease in conductivity of the peripheral wiring can be suppressed.

In addition, it is assumed that, in the touch sensor according to the embodiment of the present invention, since the surface of the substrate has a water contact angle of 20° or more, the water content is small in the vicinity of the surface of the substrate in the region where the peripheral wirings are disposed (particularly, the region where the peripheral wirings with a small distance S therebetween are disposed), and thus it is possible to suppress the occurrence of migration between the peripheral wirings.

Each of the members included in the touch sensor according to the embodiment of the present invention will be described in detail.

Hereinafter, the phrase “the effects of the present invention are excellent” represents that at least one of: the effect of suppressing a decrease in conductivity in the peripheral wirings; or the effect of suppressing the migration in the peripheral wirings is excellent in the touch sensor.

### Substrate

The substrate is a member functioning to support the conductive layer.

As described above, the substrate of the touch sensor according to the embodiment of the present invention has a characteristic that the surface on the side on which the conductive layer is formed has a water contact angle of 20° to 50°.

The water contact angle of the surface of the substrate is preferably 40° or less, more preferably 35° or less, and still more preferably 30° or less from the viewpoint of further improving the effects of the present invention.

In addition, from the viewpoint of further improving the effects of the present invention, the water contact angle of the surface of the substrate is preferably 22° or more, and more preferably 25° or more.

In the present specification, the water contact angle refers to a water contact angle measured according to the following method. First, a substrate to be measured is prepared, and using a contact angle meter (for example, “DM500” manufactured by Kyowa Interface Science Co., Ltd.), pure water (2 μL of a droplet) is dropwise added onto the surface of the substrate that is kept to be horizontal. The contact angle 20 seconds after the dropwise addition is measured at 10 points, and the arithmetic average value of the measurement results is defined as the water contact angle (unit: °) of the surface of the substrate. The above-described measurement test is performed according to the sessile drop method of JIS R 3257:1999 under conditions of a room temperature of 20° C.

The method of preparing a substrate whose surface has a water contact angle in the above range is not particularly limited, and examples thereof include a method in which a constituent material of the substrate is appropriately selected from the viewpoint of hydrophilicity and hydrophobicity to adjust the water contact angle of the substrate in the above range.

The substrate preferably contains a hydrophilic component as a constituent material. Examples of the hydrophilic component include a surfactant, a hydrophilic polymer, and a hydrophilic oligomer, and a surfactant is preferable.

In a case where the substrate contains a hydrophilic component (preferably, a surfactant), the substrate includes an aspect in which the substrate consists of a single mixed layer containing a main component such as a resin and a hydrophilic component, and an aspect in which the substrate consists of a multilayer structure of a support that mainly functions to support the conductive layer and an underlayer containing a hydrophilic component, and an aspect in which the substrate consists of a multilayer structure of the support and an underlayer containing a surfactant is preferable.

Examples of the substrate and the support constituting the multilayer structure with the underlayer (hereinafter, also referred to as “substrate and the like” in a case where the two are not distinguished) include a resin substrate, a glass substrate, a ceramic substrate, and a metal substrate.

The substrate and the like may be transparent substrates having a visible light (wavelength of 400 to 800 nm) transmittance of 60% or more. The visible light transmittance of the substrate and the like is preferably 80% or more, and more preferably 90% or more. The upper limit thereof is not particularly limited, but is less than 100% in many cases. Examples of the transparent substrate include a resin substrate, a glass substrate, and a ceramic substrate.

Among these, a flexible substrate is preferable from the viewpoint of excellent bendability. Examples of the flexible substrate include the above-described resin substrate.

In addition, the substrate and the like may have a three-dimensional shape. That is, the touch sensor may have a three-dimensional shape.

As a material constituting the substrate, a resin having a melting point of about 290° C. or lower such as polyethylene terephthalate (PET) (258° C.), polycycloolefin (134° C.), polycarbonate (250° C.), an acrylic resin (128° C.), polyethylene naphthalate (269° C.), polyethylene (135° C.), polypropylene (163° C.), polystyrene (230° C.), polyvinyl chloride (180° C.), polyvinylidene chloride (212° C.), or triacetyl cellulose (290° C.) is preferable. PET, polycycloolefin, or polycarbonate is more preferable, and PET is still more preferable. The numerical value in the brackets is the melting point or the glass transition temperature.

The content of the resin contained in the substrate is not particularly limited, but is preferably 80% by mass or more, and more preferably 90% by mass or more with respect to the total mass of the substrate. The upper limit thereof may be 100% by mass with respect to the total mass of the substrate.

### Surfactant

In a case where the substrate contains a surfactant, the type of the surfactant is not particularly limited. Examples thereof include a nonionic surfactant, an anionic surfactant, a cationic surfactant, and an amphoteric surfactant, and a nonionic surfactant is preferable.

Examples of the nonionic surfactant include a polyoxyethylene alkyl ether, a polyoxyethylene alkyl aryl ether, a polyoxyethylene alkyl phenyl ether, a polyoxyalkylene monoalkyl ether, a propylene oxide/ethylene oxide block polymer, a sorbitan fatty acid ester, a polyoxyethylene sorbitan fatty acid ester, a polyoxyethylene sorbitol fatty acid ester, a glycerin fatty acid ester, a polyoxyethylene fatty acid ester, and an alkyl (poly)glycoside.

Examples of commercially available nonionic surfactants include “POLYFLOW KL-510” (solid content: 100%, component: polyoxyalkylene monoalkyl ether) manufactured by TEGO, “SN984” (solid content: 100%, component: polyether-based compound) manufactured by SAN NOPCO LIMITED, “SN366” (solid content: 100%, component: polyoxyethylene fatty acid ester) manufactured by SAN NOPCO LIMITED, “NEWCOL 1004” (solid content: 100%, component: polyoxyethylene-2-ethylhexyl ether) manufactured by DKS Co. Ltd., “DMH-40” (solid content: 100%, component: polyoxyethylene alkyl ether) manufactured by DKS Co. Ltd., “NOIGEN 140A” (solid content: 100%, component: polyoxyethylene-alkyl phenyl ether) manufactured by DKS Co. Ltd., and “PLURONIC (registered trademark) L-44” (solid content 100%, component: propylene oxide/ethylene oxide block polymer) manufactured by ADEKA Corporation.

The surfactant may be used alone, or two or more types thereof may be used in combination.

### Underlayer

In a case where the substrate is composed of a multilayer structure of a support and an underlayer containing a hydrophilic component, the underlayer is not particularly limited as long as it is a layer containing a surfactant.

The underlayer is disposed on the surface of the substrate on which the conductive layer is formed. In a case where the substrate consists of a multilayer structure of a support and an underlayer, an underlayer containing a surfactant is preferably disposed on both surfaces of the support.

The surfactant that is contained in the underlayer is as described above, including the preferred aspects thereof.

The content of the surfactant that is contained in the underlayer is preferably 0.5% to 20% by mass, and more preferably 1% to 15% by mass with respect to the total mass of the underlayer.

The underlayer may contain a polymer other than the surfactant.

Examples of the polymer that may be contained in the underlayer include a crosslinked polymer having a crosslinking structure and a linear polymer.

The crosslinked polymer refers to a polymer in which polymer chains are bonded to each other by a crosslinking structure to form a two-dimensional or three-dimensional net-like network. The type of the crosslinked polymer is not particularly limited, and examples thereof include a polymer having a urethane structure (—NH—(C—O)—).

The molecular weight between crosslinking points of the crosslinked polymer is preferably more than 20,000 and 500,000 or less. The molecular weight between crosslinking points can be obtained by performing solid viscoelasticity measurement.

The linear polymer refers to a polymer in which repeating units are one-dimensionally bonded and no branched structure is included in the bonding of the repeating units. As the linear polymer, a known polymer can be used, and examples thereof include a copolymer (nitrile rubber) of acrylonitrile and 1,3-butadiene, hydrogenated nitrile rubber, a copolymer (acrylic polymer) containing a repeating unit derived from an acrylic acid and/or a methacrylic acid, a copolymer (acrylic polymer) containing a repeating unit derived from an acrylic acid derivative and/or a methacrylic acid derivative, and a urethane polymer.

The weight-average molecular weight of the linear polymer is, for example, 500 to 500,000, and preferably 1,000 to 100,000.

The polymer that is contained in the underlayer may be used alone, or two or more types thereof may be used in combination.

The content of the polymer that is contained in the underlayer is not particularly limited. The polymer may be a remainder of the surfactant, and for example, the content of the polymer may be 80% to 99.5% by mass with respect to the total mass of the underlayer.

The underlayer may contain a component other than the surfactant and the polymer. Examples of the component include an oligomer and a polymerization initiator.

The thickness of the underlayer is, for example, 0.3 to 20 μm, preferably 0.5 to 10 μm, and more preferably 1 to 5 μm.

### Method of Forming Underlayer

Examples of the method of forming the underlayer include a method in which a composition for forming an underlayer containing a component that is contained in the underlayer is brought into contact with the support to form the underlayer on the surface of the support.

The method of bringing the support into contact with the composition for forming an underlayer is not particularly limited, and examples thereof include a method of applying the composition for forming an underlayer to the surface of the support and a method of immersing the support in the composition for forming an underlayer. A drying treatment may be optionally performed to remove the solvent contained in the composition for forming an underlayer after the composition for forming an underlayer is brought into contact with the support.

In addition, an underlayer may be formed on a surface of a temporary support different from the support in the same manner as described above, a surface of the underlayer formed on the temporary support on a side opposite to the temporary support may be bonded to one surface of the support, and the temporary support may be peeled off at an interface between the temporary support and the underlayer to provide the underlayer on the surface of the support.

In addition, the composition for forming an underlayer may contain a solvent. The type of the solvent is not particularly limited, and examples thereof include water and an organic solvent. Examples of the organic solvent include known organic solvents (for example, an alcohol-based solvent, an ether-based solvent, an ester-based solvent, a ketone-based solvent, a halogen-based solvent, and a hydrocarbon-based solvent).

Regarding the underlayer, a composition containing a precursor of a polymer that may be contained in the underlayer may be brought into contact with the support to form a precursor layer of an underlayer, and then the precursor may be polymerized to form a polymer. Examples of the treatment for polymerizing the precursor include an exposure treatment.

In a case where the exposure treatment is performed, the composition for forming an underlayer and the precursor layer of an underlayer preferably contain a polymerization initiator. The polymerization initiator is appropriately selected according to the type of the precursor of the polymer.

The thickness of the substrate is not particularly limited, and is preferably 20 to 1,000 μm, and more preferably 25 to 200 μm from the viewpoint of a balance between handleability and thickness reduction.

### Conductive Layer

The conductive layer is a layer that is formed on a surface of the substrate, and has a touch detection electrode composed of a plurality of fine metal wires disposed in a mesh shape, an electrode connection terminal electrically connected to the touch detection electrode, and a peripheral wiring electrically connected to the electrode connection terminal.

The first conductive layer 2 and the second conductive layer 3 shown in FIG. 1 are exemplary preferred aspects of the conductive layer of the touch sensor according to the embodiment of the present invention.

The touch sensor according to the embodiment of the present invention is not limited to the aspect shown in FIG. 1.

For example, the touch sensor 10 shown in FIG. 1 includes the first conductive layer 2 and the second conductive layer 3 formed on both of the surfaces 1A and 1B of the substrate 1, respectively, but the conductive layer may be formed only on one surface of the substrate. That is, the touch sensor according to embodiment of the present invention may be a touch sensor including a substrate and a conductive layer formed only on one surface of the substrate, in which the surface of the substrate on which the conductive layer is formed has a water contact angle of 20° to 50°.

Next, the peripheral wiring and the touch detection electrode of the conductive layer will be described in more detail.

### Peripheral Wiring

The peripheral wiring has a function of transmitting an electric signal detected by the touch detection electrode to an external apparatus by electrically connecting the electrode connection terminal and the external connection terminal.

In FIG. 2, all of the plurality of peripheral wirings 13 extend in the X direction (first direction) and are arranged in the Y direction (second direction) perpendicular to the X direction. However, FIG. 2 shows the arrangement form of the peripheral wirings 13 in a part of the entire length of the peripheral wirings 13 connecting the electrode connection terminals 12 and the external connection terminals 14. As shown in FIG. 1, the peripheral wirings 13 connect the electrode connection terminals 12 and the external connection terminals 14 while changing their extending direction according to the arrangement of the electrode connection terminals 12, the external connection terminals 14, and other members.

From the viewpoint of easily realizing frame narrowing, it is preferable that, in at least a part of the region where the peripheral wirings are disposed on the surface of the substrate, at least one of the distance S between two peripheral wirings adjacent to each other or the line width L of the peripheral wirings be in a predetermined range, and it is more preferable that the distance S between peripheral wirings be in a predetermined range.

Specifically, the distance S between peripheral wirings is preferably 50 μm or less, more preferably 30 μm or less, and still more preferably 15 μm or less.

In addition, the line width L of the peripheral wirings is preferably 50 μm or less, more preferably 30 μm or less, and still more preferably 15 μm or less.

In the touch sensor according to the embodiment of the present invention, it is possible to suppress a decrease in conductivity of the peripheral wirings and the occurrence of migration between the peripheral wirings, even in a case where the distance S between the peripheral wirings and/or the line width L of the peripheral wirings are in the above range due to the frame narrowing in at least a part of the region where the peripheral wirings are disposed.

The distance S between the peripheral wirings is preferably 5 μm or more, and more preferably 10 μm or more from the viewpoint of further improving the effect of suppressing the migration.

In addition, the line width L of the peripheral wirings is preferably 3 μm or more, and more preferably 5 μm or more from the viewpoint that sufficient conductive properties can be ensured.

In the present specification, the line width of the peripheral wirings is intended to mean a line width measured by observing a length in a direction perpendicular to a direction in which each member of the touch sensor extends with an optical microscope (for example, digital microscope “VHX-7000” manufactured by KEYENCE CORPORATION). Specifically, the line width is measured at 10 points arbitrarily selected in the conductive layer by the above-described optical microscope observation, and the measurement values are arithmetically averaged to calculate the line width of the peripheral wirings.

In addition, for example, the phrase “the distance S between the peripheral wirings is 30 μm or less in at least a part of the region where the peripheral wirings are disposed” means that, in a section with a length of 1,000 μm where the plurality of peripheral wirings extend in one direction, the distance S between the peripheral wirings that is determined by the following method is 30 μm or less. More specifically, in a target section with a length of 1,000 μm where the plurality of peripheral wirings to be measured extend in one direction, 5 points that include both ends of the target section and are spaced at equal intervals from each other are selected, and observed with an optical microscope according to the above-described method. Next, the distance between two peripheral wirings adjacent to each other is measured from the observed image, and the measurement values obtained at 5 points are arithmetically averaged to calculate the distance S between the peripheral wirings in the target section.

### Touch Detection Electrode

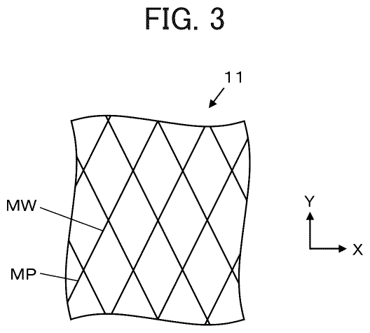

FIG. 3 is an enlarged plan view showing an example of a configuration of the touch detection electrode of the conductive layer of the touch sensor according to the embodiment of the present invention. As shown in FIG. 3, the touch detection electrode 11 is composed of a plurality of fine metal wires MW disposed in a mesh shape, and functions as a sensor electrode for detecting a so-called touch operation.

The mesh shape is intended to mean a shape including a plurality of opening portions formed by the intersecting fine metal wires MW. The opening portion is an opening region surrounded by the fine metal wires MW. In the touch detection electrode 11 shown in FIG. 3, the plurality of fine metal wires MW form a mesh-like pattern MP in which opening portions have a rhombic shape. The shape of the mesh pattern of the touch detection electrode is not limited to the rhombic shape, and the mesh pattern may have other shapes.

Examples of the shape of the mesh pattern of the touch detection electrode include triangles such as a regular triangle, an isosceles triangle, and a right triangle, quadrangles such as a square, a rectangle, a rhombus, a parallelogram, and a trapezoid, (regular) n-polygons such as a (regular) hexagon and a (regular) octagon, a circle, an ellipse, a star shape, and a geometrical figure as a combination of the above shapes. In addition, in the opening portion, the shape of one side may be a curved shape or may be an arc shape in addition to a linear shape. In a case where the shape of one side is an arc shape, for example, two sides facing each other may have an arc shape that is outwardly convex, and the other two sides facing each other may have an arc shape that is inwardly convex. In addition, the shape of each of the sides may have a wavy line shape in which an arc that is outwardly convex and an arc that is inwardly convex are continuous. Of course, the shape of each of the sides may be a sine curve shape. The mesh pattern is not particularly limited, and may be a random pattern or a regular pattern or may be a regular mesh pattern in which a plurality of congruent shapes are repeatedly disposed.

The mesh pattern of the touch detection electrode is preferably a regular mesh pattern having the same rhombic lattice. The length of one side of the rhombus, that is, the length of one side of the opening portion is preferably 50 to 1,500 μm, more preferably 150 to 800 μm, and still more preferably 200 to 600 μm from the viewpoint of visibility. In a case where the length of one side of the opening portion is in the above range, it is possible to maintain good transparency, and in a case where the touch sensor is attached to the display surface of an image display device, it is possible to visually recognize a display image without an uncomfortable feeling.

The opening ratio of the mesh pattern of the touch detection electrode is preferably 90% or more, and more preferably 95% or more from the viewpoint of visible light transmittance. The opening ratio corresponds to an area ratio of opening portions other than the fine metal wires MW in a region where the touch detection electrode is provided, to the entire region where the touch detection electrode is provided.

The mesh pattern of the touch detection electrode can be observed and measured using an optical microscope.

From the viewpoint of more excellent visibility, a line width W of the fine metal wires MW constituting the mesh pattern of the touch detection electrode is preferably 10 μm or less, more preferably 5 μm or less, and still more preferably 3 μm or less. The lower limit thereof is not particularly limited, but from the viewpoint of more excellent conductive characteristics of the fine metal wires, it is preferably 0.5 μm or more, and more preferably 1 μm or more.

In the touch sensor according to the embodiment of the present invention, the peripheral wiring has a to-be-plated layer formed on the surface of the substrate and a metal plating layer covering the to-be-plated layer.

In addition, the members constituting the conductive layer, such as the touch detection electrodes, the electrode connection terminals, and the external connection terminals other than the peripheral wirings, that is, the entire conductive layer, preferably have a to-be-plated layer formed on the surface of the substrate and a metal plating layer covering the to-be-plated layer.

### To-Be-Plated Layer

The to-be-plated layer is a layer on which a metal plating layer covering a surface of the to-be-plated layer is formed by performing a plating treatment.

It is preferable that by formation of the conductive layer with a to-be-plated layer and a metal plating layer covering the to-be-plated layer, a to-be-plated layer patterned to correspond to a target pattern shape of the conductive layer be disposed on the surface of the substrate. For example, in a case where the touch detection electrode has a mesh shape, the to-be-plated layer disposed in the region where the touch detection electrode is formed preferably has the same mesh-like pattern as the touch detection electrode, and in a case where the touch detection electrode has a stripe shape, the to-be-plated layer preferably has the same stripe-like pattern as the touch detection electrode.

The to-be-plated layer is not particularly limited as long as the metal plating layer can be formed thereon by a plating treatment, and for example, the to-be-plated layer may be a layer containing an organic component as a main component.

Inclusion of the organic component as a main component means that the content of the organic component with respect to a total mass of the to-be-plated layer is more than 50% by mass, and the content is preferably 80% by mass or more, and more preferably 90% by mass or more. The upper limit thereof is not particularly limited and may be 99.9% by mass or less. The to-be-plated layer preferably contains a plating catalyst.

As the plating catalyst, an electroless plating catalyst is preferable.

The electroless plating catalyst is not particularly limited as long as the catalyst serves as an active nucleus in an electroless plating treatment, and examples thereof include metals (metals known to have a lower ionization tendency than Ni and to be usable in the electroless plating treatment) having catalytic activity of an autocatalytic reduction reaction. Specific examples thereof include Pd, Ag, Cu, Pt, Au, and Co.

As the organic component contained in the to-be-plated layer, a compound obtained by adsorbing a plating catalyst to a compound having a functional group (hereinafter, also referred to as “interactive group”) that interacts with the plating catalyst or its precursor is preferable.

The interactive group is intended to mean a functional group capable of interacting with a plating catalyst or its precursor, which are imparted to the to-be-plated layer, and examples thereof include a functional group that can form an electrostatic interaction with the plating catalyst or its precursor, and a nitrogen-containing functional group, a sulfur-containing functional group, and an oxygen-containing functional group, that can form a coordination with the plating catalyst or its precursor.

As the interactive group, from the viewpoint of high polarity and high adsorption ability to the plating catalyst or its precursor, an ionic polar group such as a carboxylic acid group, a sulfonic acid group, a phosphoric acid group, and a boronic acid group, or a cyano group is preferable, and a carboxylic acid group or a cyano group is more preferable.

As the compound having the above-described interactive group, a polymer having an interactive group is preferable, and a polymer containing a repeating unit having an interactive group is more preferable. That is, the to-be-plated layer preferably contains a compound obtained by adsorbing a plating catalyst to a polymer having an interactive group (more preferably, a polymer containing a repeating unit having an interactive group).

The thickness of the to-be-plated layer is not particularly limited, and is preferably 0.05 to 2.0 μm, and more preferably 0.1 to 1.0 μm from the viewpoint that a plating catalyst or its precursor can be sufficiently carried and abnormal plating is prevented.

The line width of the to-be-plated layer is appropriately selected depending on which member, such as the touch detection electrode, electrode connection terminal, and peripheral wiring, does the conductive layer formed by the plating treatment constitute, the specific plating treatment method, or the like.

### Method of Forming To-Be-Plated Layer

The method of forming the to-be-plated layer is not particularly limited, and examples thereof include a method in which a precursor layer of a to-be-plated layer is formed by bringing a composition for forming a to-be-plated layer containing a component to be contained in the to-be-plated layer into contact with the substrate, and subjected to an exposure treatment and a development treatment to form a patterned to-be-plated layer, and a plating catalyst or its precursor is imparted to the obtained to-be-plated layer.

Examples of the composition for forming a to-be-plated layer include a composition containing the following compound X or composition Y.
Compound X: A compound having an interactive group and a polymerizable group
Composition Y: A composition including a compound having an interactive group and a compound having a polymerizable group

The compound X is a compound having an interactive group and a polymerizable group. The definition of the interactive group is as described above.

The compound X may have two or more interactive groups.

The polymerizable group is a functional group capable of forming a chemical bond by energy application, and examples thereof include a radically polymerizable group and a cationically polymerizable group. Among these, a radically polymerizable group is preferable from the viewpoint of a more excellent reactivity. As the radically polymerizable group, a methacryloyloxy group, an acryloyloxy group, or a styryl group is more preferable.

The compound X may have two or more polymerizable groups. In addition, the number of the polymerizable groups of the compound X is not particularly limited, and may be one or two or more.

The compound X may be a low-molecular-weight compound or a high-molecular-weight compound. The low-molecular-weight compound is intended to mean a compound having a molecular weight less than 1,000, and the high-molecular-weight compound is intended to mean a compound having a molecular weight (in a case where the molecular weight has a distribution, a weight-average molecular weight) of 1,000 or more.

In a case where the compound X is a polymer, the weight-average molecular weight of the polymer is not particularly limited, and is preferably 1,000 to 700,000, and more preferably 2,000 to 200,000 from the viewpoint of more excellent handleability such as solubility.

The method of synthesizing such a polymer having a polymerizable group and an interactive group is not particularly limited, and a known synthesis method (refer to paragraphs [0097] to [0125] of JP2009-280905A) is applied.

The composition Y is a composition containing a compound having an interactive group and a compound having a polymerizable group. That is, the composition Y contains two types of compounds: a compound having an interactive group; and a compound having a polymerizable group. The definitions of the interactive group and the polymerizable group are as described above.

The compound having an interactive group may be a low-molecular-weight compound or a high-molecular-weight compound. In addition, the compound having an interactive group may contain a polymerizable group.

Preferred aspects of the compound having an interactive group include a polymer including a repeating unit having an interactive group (for example, a polyacrylic acid).

Preferred aspects of the polymer including a repeating unit having an interactive group include a polymer X having a repeating unit derived from a conjugated diene compound and a repeating unit derived from an unsaturated carboxylic acid or a derivative thereof since the to-be-plated layer is easily formed with a small amount of energy applied (for example, an exposure amount).

The conjugated diene compound is not particularly limited as long as it is a compound having a molecular structure that has two carbon-carbon double bonds separated by one single bond.

The repeating unit derived from a conjugated diene compound is preferably a repeating unit derived from a compound having a butadiene skeleton. Examples of the compound having a butadiene skeleton (a monomer having a butadiene structure) include 1,3-butadiene, isoprene, 2-ethyl-1,3-butadiene, 2-n-propyl-1,3-butadiene, 2,3-dimethyl-1,3-butadiene, 1-phenyl-1,3-butadiene, 1-α-naphthyl-1,3-butadiene, 1-β-naphthyl-1,3-butadiene, 2-chloro-1,3-butadiene, 1-bromo-1,3-butadiene, 1-chlorobutadiene, 2-fluoro-1,3-butadiene, 2,3-dichloro-1,3-butadiene, 1,1,2-trichloro-1,3-butadiene, and 2-cyano-1,3-butadiene.

The content of the repeating unit derived from a conjugated diene compound in the polymer X is preferably 25% to 75% by mole with respect to all the repeating units.

The content of the repeating unit derived from an unsaturated carboxylic acid or a derivative thereof in the polymer X is preferably 25% to 75% by mole with respect to all the repeating units.

The compound having a polymerizable group is a so-called monomer, and a polyfunctional monomer having two or more polymerizable groups is preferable from the viewpoint that the hardness of a patterned to-be-plated layer to be formed is more excellent. Specifically, the polyfunctional monomer is preferably a monomer having 2 to 6 polymerizable groups. The molecular weight of the polyfunctional monomer to be used is preferably 150 to 1,000, and more preferably 200 to 800 from the viewpoint of the mobility of molecules during the crosslinking reaction that affects the reactivity.

The composition for forming a to-be-plated layer may contain components other than the above-described components.

For example, the composition for forming a to-be-plated layer may contain a polymerization initiator. The type of the polymerization initiator is not particularly limited, and examples thereof include a known polymerization initiator (preferably a photopolymerization initiator).

The composition for forming a to-be-plated layer may contain a solvent. The type of the solvent is not particularly limited, and examples thereof include water and an organic solvent. Examples of the organic solvent include known organic solvents (for example, an alcohol-based solvent, an ester-based solvent, a ketone-based solvent, a halogen-based solvent, and a hydrocarbon-based solvent).

In the exposure treatment that is performed on the precursor layer of a to-be-plated layer, the precursor layer of a to-be-plated layer is irradiated with light in a patterned shape to obtain a desired patterned to-be-plated layer. The type of light used is not particularly limited, and examples thereof include ultraviolet light and visible light. In the light irradiation in a patterned shape, the light irradiation is preferably performed using a mask having an opening portion having a predetermined shape.

In the exposed portion of the precursor layer of a to-be-plated layer, the polymerizable group contained in the compound in the precursor layer of a to-be-plated layer is activated, crosslinking occurs between the compounds, and curing of the layer proceeds.

Next, by performing a development treatment on the precursor layer of a to-be-plated layer cured in a patterned shape, an unexposed portion is removed, and thus a patterned to-be-plated layer is formed. The formed to-be-plated layer has shapes corresponding to the conductive layers of the touch detection electrode, the electrode connection terminal, and the peripheral wiring.

The development treatment method is not particularly limited, and an optimal development treatment is performed according to the type of the material to be used. Examples of a developer include an organic solvent, pure water, and an alkaline aqueous solution.

Next, a plating catalyst or its precursor is imparted to the patterned to-be-plated layer that has been formed. Since the to-be-plated layer has the above-described interactive group, the plating catalyst or its precursor imparted to the to-be-plated layer adheres (adsorbs) to the interactive group according to the function of the interactive group.

The plating catalyst or its precursor imparted to the to-be-plated layer functions as a catalyst or an electrode for the plating treatment to be described later. Therefore, the type of the plating catalyst or its precursor to be used is appropriately determined according to the type of the plating treatment.

Examples of the method of imparting the plating catalyst or its precursor to the to-be-plated layer include a method in which a solution in which the plating catalyst or its precursor is dispersed or dissolved in a solvent is prepared, and the solution is applied to a surface of the to-be-plated layer, and a method in which a substrate with the to-be-plated layer is immersed in the solution.

As the plating catalyst, an electroless plating catalyst is preferable. The electroless plating catalyst is as described above. As the electroless plating catalyst, a metal colloid may be used.

An electroless plating catalyst precursor is not particularly limited as long as it becomes an electroless plating catalyst by a chemical reaction, and examples thereof include ions of the metals mentioned above as the electroless plating catalyst. The metal ions serving as the electroless plating catalyst precursor are converted into a zero-valent metal that is an electroless plating catalyst by a reduction reaction. After imparted to the patterned to-be-plated layer, the metal ions serving as the electroless plating catalyst precursor may be changed into a zero-valent metal as an electroless plating catalyst by a separate reduction reaction before immersed in an electroless plating bath. The electroless plating catalyst precursor may be immersed in an electroless plating bath as it is and changed into a metal (electroless plating catalyst) by a reducing agent in the electroless plating bath.

Examples of the solvent include water and an organic solvent.

### Metal Plating Layer

The metal plating layer is a layer formed by performing a plating treatment on the to-be-plated layer.

Examples of the metal material contained in the metal plating layer include metals such as gold (Au), silver (Ag), copper (Cu), and aluminum (Al), and alloys containing these metals. Among these, silver or copper is preferably contained, and copper is more preferably contained in the metal plating layer from the viewpoint of excellent conductive properties of the conductive layer.

Examples of the metal plating layer containing copper include a layer consisting of a copper simple substance (metallic copper) and a layer consisting of a mixture (copper alloy) containing copper and a metal other than the copper, and a layer consisting of a copper simple substance is preferable. Examples of the metal other than the copper contained in the copper alloy include silver, gold, aluminum, nickel, molybdenum, chromium, and palladium.

The metal plating layer is not limited to being composed of a single layer containing a metal, and may be composed of a multilayer structure consisting of two or more metal layers having different compositions.

It is preferable that the metal plating layer have no layer containing a compound of a metal such as a metal oxide and an atom other than the metal.

The thicknesses of the metal plating layer and the conductive layer are not particularly limited, and are preferably 0.1 to 5.0 μm, and more preferably 0.2 to 3.0 μm from the viewpoint of lower resistance and more excellent adhesiveness.

### Method of Forming Metal Plating Layer

The plating treatment method for forming the metal plating layer is not particularly limited, and examples thereof include an electroless plating treatment and an electrolytic plating treatment (electroplating treatment).

The method of forming the metal plating layer preferably has a step of performing an electroless plating treatment on the to-be-plated layer to which the plating catalyst or its precursor has been imparted.

The metal plating layer may be a layer formed by performing an electroless plating treatment alone, or a layer formed by performing an electroless plating treatment and then further performing an electrolytic plating treatment.

In addition, the plating treatment may be repeated a plurality of times, and in that case, a plating liquid containing a different metal for each plating treatment may be used.

In the plating treatment, the line width and the thickness of the metal plating layer can be adjusted depending on the composition of the plating liquid, the plating temperature, the plating time, and the like.

The electroless plating treatment refers to a treatment of precipitating a metal by a chemical reaction using a solution in which metal ions expected to be precipitated as plating are dissolved.

Examples of the electroless plating treatment include a method in which a substrate including a to-be-plated layer to which a plating catalyst has been imparted is water-washed to remove the excess plating catalyst, and then immersed in an electroless plating bath. As the electroless plating bath, a known electroless plating bath can be used.

In the composition of a general electroless plating bath, in addition to a solvent (for example, water), metal ions for plating, a reducing agent, and an additive (stabilizer) that improves stability of the metal ions are mainly contained. The plating bath may further contain a known additive such as a stabilizer of a plating bath in addition to the above-described components.

The organic solvent used in the electroless plating bath needs to be soluble in water, and from this viewpoint, ketones such as acetone or alcohols such as methanol, ethanol, and isopropanol are preferably used. The electroless plating bath contains a metal corresponding to a target metal plating layer. As the reducing agent and additive contained in the electroless plating bath, an optimum reducing agent and additive are selected according to the above metal.

The immersion time in the electroless plating bath is, for example, about 1 minute to 6 hours, and preferably about 1 minute to 3 hours.

### Method of Producing Touch Sensor

The touch sensor according to the embodiment of the present invention can be produced by, for example, a producing method having the following steps 1 to 4.
Step 1: A step of preparing a substrate having a water contact angle on a surface of 20° to 50°
Step 2: A step of forming a patterned to-be-plated layer on the surface of the substrate
Step 3: A step of imparting a plating catalyst or its precursor to the patterned to-be-plated layer formed on the surface of the substrate
Step 4: A step of performing a plating treatment on the patterned to-be-plated layer to which the plating catalyst or its precursor has been imparted to form a metal plating layer

The step 1 is as described above, and a substrate with an underlayer is preferably produced according to the method of forming an underlayer described above.

The steps 2 and 3 are preferably performed according to the method of forming a to-be-plated layer described above.

The step 4 is preferably performed according to the method of forming a metal plating layer described above.

A touch sensor in which a conductive layer is disposed on both surfaces of a substrate as shown in FIG. 1 can be produced by preparing a substrate whose both surfaces have a water contact angle of 20° to 50° and forming a to-be-plated layer and a metal plating layer according to the steps 2 to 4.

The touch sensor may be used in the form of a laminate having a touch sensor and other members such as a pressure-sensitive adhesive sheet and a peeling sheet during handling and transportation. The peeling sheet functions as a protective sheet for preventing the occurrence of scratching on the conductive member during transportation of the laminate. In addition, the touch sensor may be handled, for example, in the form of a composite body having the touch sensor, a pressure-sensitive adhesive sheet, and a protective layer in this order.

### Touch Panel

The touch sensor according to the embodiment of the present invention can be preferably applied to a touch panel.

Specific aspects of the touch panel having the touch sensor according to the embodiment of the present invention include an aspect in which a touch sensor, an image display device disposed on one main surface of the touch sensor, and a cover member disposed on the other main surface of the touch sensor are provided. In the touch panel having such an aspect, a finger, a stylus pen, or the like of a user that contacts or approaches the cover member is detected, and a touch operation by the user is detected.

### EXAMPLES

Hereinafter, the present invention will be described in more detail based on the following examples.

The materials, the amounts and proportions of the materials used, the details of treatments, the procedure of treatments, and the like shown in the following examples can be appropriately modified as long as the gist of the present invention is maintained. Accordingly, the scope of the present invention will not be restrictively interpreted by the following examples.

### Preparation of Composition for Forming Underlayer

Raw material components used in the preparation of a composition for forming an underlayer are shown below.
Z913-3: “Z913-3” manufactured by Aica Kogyo Co., Ltd., weight-average molecular weight (Mw): 50,000.
HO-250: “LIGHT ESTER HO-250 (N)” manufactured by Kyoeisha Chemical Co., Ltd., 2-hydroxyethyl methacrylate
FOM-03006: “FOM-03006” manufactured by FUJIFILM Wako Pure Chemical Corporation, crosslinking compound represented by the following structural formula

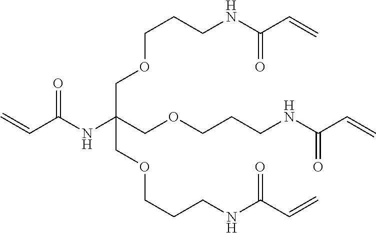 [SMILES: C=CC(=O)NCCCOCC(COCCCNC(=O)C=C)(COCCCNC(=O)C=C)NC(=O)C=C]

OXE-02: “IRGACURE (registered trademark) OXE-02” manufactured by BASF SE, oxime ester-based polymerization initiator
Surfactant A: “PLURONIC L-44” manufactured by ADEKA Corporation, solid content: 100% by mass, nonionic surfactant consisting of propylene oxide/ethylene oxide block polymer
Mixed Solvent 1: Mixture of methyl ethyl ketone (MEK) and isopropyl alcohol (IPA) at volume ratio of 1:3 (MEK:IPA)
Mixed Solvent 2: Mixture of methyl ethyl ketone (MEK) and isopropyl alcohol (IPA) at volume ratio of 1:1 (MEK:IPA)

The raw material components were mixed so that the contents thereof were as shown in Table 1, and thus compositions A to H, which are compositions for forming an underlayer, were prepared.

For example, 3 parts by mass of “Z913-3”, 0.015 parts by mass of “OXE-02”, 0.065 parts by mass of the surfactant A, and 97 parts by mass of the mixed solvent 1 were mixed, and thus the composition A were prepared.

TABLE 1

| Composition No. | | A | B | C | D | E | F | G | H |
|---|---|---|---|---|---|---|---|---|---|
| Composition | Z913-3 | 3 | 3 | 3 | 3 | 3 | 3 | — | 3 |
| (parts by | HO-250 | — | — | — | — | — | — | 2.7 | — |
| mass) | FOM-03006 | — | — | — | — | — | — | 0.3 | — |
| | OXE-02 | 0.015 | 0.015 | 0.015 | 0.015 | 0.015 | 0.015 | 0.015 | 0.015 |
| | Surfactant A | 0.065 | 0.100 | 0.130 | 0.180 | 0.500 | — | — | 0.800 |
| | Mixed Solvent 1 | 97 | 97 | 97 | 97 | 97 | 97 | — | 97 |
| | Mixed Solvent 2 | — | — | — | — | — | — | 97 | — |

### Preparation of Composition for Forming To-Be-Plated Layer

The following components were mixed to obtain a composition for forming a to-be-plated layer.

| | | |
|---|---|---|
| Isopropanol | 38 | parts by mass |
| Polybutadiene Maleic Acid (butadiene-maleic | 4 | parts by mass |
| acid alternating copolymer, repeating unit | | |
| derived from butadiene:repeating unit | | |
| derived from maleic acid = 1:1 | | |
| (molar ratio), manufactured by | | |
| Polysciences, Inc.) | | |
| FAM-201 (bifunctional acrylamide, manufactured | 1 | part by mass |
| by FUJIFILM Wako Pure Chemical Corporation) | | |
| IRGACURE-OXE02 (oxime ester-based | 0.05 | parts by mass |
| polymerization initiator, | | |
| manufactured by BASF SE) | | |

### Example 1

### Formation of Underlayer

The above-described composition A was applied to one surface of a polyester film having an easy adhesion layer on both surfaces with a thickness of 50 μm (COSMOSHINE (registered trademark) A4360 manufactured by TOYOBO Co., Ltd.) by a bar coating method, and the coating film was dried at 120° C. to form a precursor layer of an underlayer having a thickness of 1.2 μm. The formed precursor layer of an underlayer was irradiated with ultraviolet rays at an exposure amount of 500 mJ/cm² to produce a substrate having an underlayer A containing the crosslinked polymer and the surfactant A.

Production of Substrate with To-Be-Plated Layer

The above-described composition for forming a to-be-plated layer was applied to a surface of the underlayer A of the produced substrate by a bar coating method. In that case, the amount of the composition for forming a to-be-plated layer applied was adjusted so that the layer thickness after drying was about 0.3 μm. The coating film was dried at a temperature of 120° C. for 1 minute, and a precursor layer of a to-be-plated layer was formed. After the precursor layer of a to-be-plated layer was formed, a polypropylene protective film having a thickness of 12 μm was immediately attached to a surface of the precursor layer of a to-be-plated layer.

An exposure mask having exposure patterns corresponding to a plurality of touch detection electrodes 11, a plurality of electrode connection terminals 12, a plurality of peripheral wirings 13, and a plurality of external connection terminals 14 as shown in FIG. 1 was disposed on the substrate with the to-be-plated layer precursor with the protective film attached thereto.

The substrate with the precursor layer of a to-be-plated layer was irradiated with ultraviolet rays at 30 mJ/cm² using a high-pressure mercury lamp through the exposure mask. After the irradiation with ultraviolet rays, the protective film was peeled off from the substrate with the precursor layer of a to-be-plated layer. The substrate with the precursor layer of a to-be-plated layer, from which the protective film had been peeled off, was subjected to an alkali development treatment by showing cleaning with a 1% by mass sodium carbonate aqueous solution, and a substrate with a to-be-plated layer was obtained.

The formed to-be-plated layer had shapes corresponding to the mesh-like touch detection electrodes 11, the electrode connection terminals 12, the peripheral wirings 13, and the external connection terminals 14.

Production of Substrate (Touch Sensor) with Copper Plating Layer

A Pd catalyst-imparting liquid “Omnishield 1573 activator” (manufactured by Rohm and Haas Electronic Materials LLC) was diluted with pure water to 4.8% by volume, and the pH (hydrogen ion exponent) was adjusted to 4 with 0.1 N hydrochloric acid. In the obtained resulting aqueous solution, the substrate with the to-be-plated layer was immerse at a temperature of 45° C. for 8 minutes. Thereafter, the substrate with the to-be-plated layer was cleaned twice with pure water.

Next, the substrate with the to-be-plated layer was immersed in a 0.8% by volume aqueous solution of a reducing agent “CIRCUPOSIT PB Oxide converter 60C” (manufactured by Rohm and Haas Electronic Materials LLC) at a temperature of 30° C. for 5 minutes. Then, the substrate with the to-be-plated layer was cleaned twice with pure water and subjected to a Pd catalyst treatment.

Next, the substrate with the to-be-plated layer that had been subjected to the Pd catalyst treatment was immersed in an electroless plating liquid obtained by mixing 12% by volume of an M agent, 6% by volume of an A agent, and 10% by volume of a B agent of “CIRCUPOSIT 4500” (manufactured by Rohm and Haas Electronic Materials LLC) at a temperature of 50° C. for 30 minutes. Then, the substrate treated with the electroless plating liquid was cleaned with pure water, and thus a substrate (touch sensor) with a copper plating layer in which a copper plating layer covering the to-be-plated layer was provided was obtained.

The obtained touch sensor had a conductive layer including a plurality of touch detection electrodes 11, a plurality of electrode connection terminals 12, a plurality of peripheral wirings 13, and a plurality of external connection terminals 14 as shown in FIG. 3. In addition, in the obtained touch sensor, a line width L of each peripheral wiring was 35 μm, and a distance S between two peripheral wirings disposed adjacent to each other was 35 μm.

### Example 2

A touch sensor of Example 2 was produced in the same manner as in Example 1, except that in the step of forming an underlayer, an underlayer B was formed using the above-described composition B as the composition for forming an underlayer, and in the step of producing a substrate with a to-be-plated layer, a substrate having the underlayer B was used.

### Example 3

A touch sensor of Example 3 was produced in the same manner as in Example 1, except that in the step of forming an underlayer, an underlayer C was formed using the above-described composition C as the composition for forming an underlayer, and in the step of producing a substrate with a to-be-plated layer, a substrate having the underlayer C was used, and an exposure mask was used having an exposure pattern having such a shape that a copper plating layer having a conductive pattern in which both the line width L and the distance S of the peripheral wirings were 30 μm was formed.

### Example 4

A touch sensor of Example 4 was produced in the same manner as in Example 1, except that in the step of forming an underlayer, an underlayer D was formed using the above-described composition D as the composition for forming an underlayer, and in the step of producing a substrate with a to-be-plated layer, a substrate having the underlayer D was used, and an exposure mask was used having an exposure pattern having such a shape that a copper plating layer having a conductive pattern in which both the line width L and the distance S of the peripheral wirings were 15 μm was formed.

### Example 5

A touch sensor of Example 5 was produced in the same manner as in Example 4, except that in the step of producing a substrate with a to-be-plated layer, an exposure mask was used having an exposure pattern having such a shape that a copper plating layer having a conductive pattern in which both the line width L and the distance S of the peripheral wirings were 10 μm was formed.

### Example 6

A touch sensor of Example 6 was produced in the same manner as in Example 1, except that in the step of forming an underlayer, an underlayer E was formed using the above-described composition E as the composition for forming an underlayer, and in the step of producing a substrate with a to-be-plated layer, a substrate having the underlayer E was used, and an exposure mask was used having an exposure pattern having such a shape that a copper plating layer having a conductive pattern in which both the line width L and the distance S of the peripheral wirings were 15 μm was formed.

### Comparative Example 1

A touch sensor of Comparative Example 1 was produced in the same manner as in Example 1, except that in the step of forming an underlayer, an underlayer F was formed using the above-described composition F as the composition for forming an underlayer, and in the step of producing a substrate with a to-be-plated layer, a substrate having the underlayer F was used.

### Comparative Example 2

A touch sensor of Comparative Example 2 was produced in the same manner as in Example 1, except that in the step of forming an underlayer, an underlayer F was formed using the above-described composition F as the composition for forming an underlayer, and in the step of producing a substrate with a to-be-plated layer, a substrate having the underlayer F was used, and an exposure mask was used having an exposure pattern having such a shape that a copper plating layer having a conductive pattern in which both the line width L and the distance S of the peripheral wirings were 15 μm was formed.

### Comparative Example 3

A touch sensor of Comparative Example 3 was produced in the same manner as in Example 1, except that in the step of forming an underlayer, an underlayer G was formed using the above-described composition G as the composition for forming an underlayer, and in the step of producing a substrate with a to-be-plated layer, a substrate having the underlayer G was used, and an exposure mask was used having an exposure pattern having such a shape that a copper plating layer having a conductive pattern in which both the line width L and the distance S of the peripheral wirings were 15 μm was formed.

### Comparative Example 4

A touch sensor of Comparative Example 4 was produced in the same manner as in Example 1, except that in the step of forming an underlayer, an underlayer H was formed using the above-described composition H as the composition for forming an underlayer, and in the step of producing a substrate with a to-be-plated layer, a substrate having the underlayer H was used, and an exposure mask was used having an exposure pattern having such a shape that a copper plating layer having a conductive pattern in which both the line width L and the distance S of the peripheral wirings were 15 μm was formed.

### Measurement and Evaluation

The following measurement and evaluation were performed on the produced touch sensors of the examples and comparative examples.

### Water Contact Angle of Surface of Substrate

Regarding the substrates produced in the examples and comparative examples, the water contact angle (unit: °) of the surface on the side on which the conductive layer was formed (that is, the underlayer side) was measured. The water contact angle was measured according to the above-described sessile drop method using a contact angle meter (“DM500” manufactured by Kyowa Interface Science Co., Ltd.).

Table 2 shows the measurement results of the water contact angles of the surfaces of the substrates in the examples and comparative examples.

### Migration Evaluation

A migration test sample having conductive thin wires having a to-be-plated layer and a copper plating layer was produced in the same manner as in the method described in each example, except that, in order to evaluate migration in each touch sensor, a photo mask corresponding to a migration test pattern according to IPC-TM650 or SM840 was used instead of the exposure mask used in (Production of Substrate with To-Be-Plated Layer). The line width and the space width of the pattern of the conductive thin wires in the migration test sample were the same as the line width L and the distance S of each of the examples and comparative examples, and the number of lines was 17 lines or 18 lines (hereinafter, referred to as a comb-like pattern electrode).

In the above-described migration test sample, wirings were connected to both ends of the conductive thin wires. Next, as a migration test, a direct current was continuously applied to the conductive thin wires of the sample via the wirings while the sample was left in a moist and hot atmosphere at 85° C. and 85% RH, so that a voltage of 20 V was applied between both ends of the conductive thin wires.

After a predetermined time had elapsed from the start of the test, the sample was taken out from the atmosphere at 85° C. and 85% RH, and using a digital ultra-high-resistance/micro-current meter (“R8340A” manufactured by Advantest Corporation), the insulating resistance of the conductive thin wires was measured in a case where a DC voltage of 18 V was applied.

The migration of the conductive thin wires of the sample was evaluated according to the following standards, based on the elapsed time from the start of the test and the measured insulating resistance value of the conductive thin wires. The longer the time taken for which the insulating resistance value is 10¹⁰Ω or more, the more excellent the migration suppression performance. In all of the examples and comparative examples, the insulating resistance value in the sample before the start of the test was 10¹⁰Ω or more when measured by the above-described method.

### Standards for Migration Evaluation

“A”: The insulating resistance value after the elapse of 1,000 hours from the start of the test was 10¹⁰Ω or more.
“B”: The insulating resistance value after the elapse of 500 hours from the start of the test was 10¹⁰Ω or more, but the insulating resistance value after the elapse of 1,000 hours was less than 10¹⁰Ω.
“C”: The insulating resistance value after the elapse of 500 hours from the start of the test was less than 10¹⁰Ω.

### Conductivity Evaluation

In one touch sensor produced in each of the examples and comparative examples, 10 peripheral wirings were arbitrarily selected, and the resistance values between both ends of the selected peripheral wirings were measured. Peripheral wirings in which the measured resistance value was 1 kΩ or more were determined as “defective wirings”, and the number thereof was counted.

For each of the examples and comparative examples, 50 touch sensors produced by the same method were subjected to the measurement and determination according to the above-described methods. Then, the rate of occurrence of defective products was calculated from a ratio of the number of defective wirings to the total number of peripheral wirings subjected to the measurement. From the obtained rate of occurrence of defective products, the conductivity of the touch sensor was evaluated based on the following standards.

### Standards for Conductivity Evaluation

“A”: The rate of occurrence of defective products is 0.5% or less.
“B”: The rate of occurrence of defective products is more than 0.5% and 1.0% or less.
“C”: The rate of occurrence of defective products is more than 1.0% and 1.5% or less.
“D”: The rate of occurrence of defective products is more than 1.5% and 2.0% or less.
“E”: The rate of occurrence of defective products is more than 2.0%.

Table 2 shows the configurations of the touch sensors and the evaluation results.

TABLE 2

| | Substrate | | | | | | |
|---|---|---|---|---|---|---|---|
| | | | Water | | | | |
| | | | Contact | Peripheral Wirings | | | |
| | Underlayer | Composition | Angle | Line Width L | Distance S | Evaluation | |
| | No. | No. | (°) | (μm) | (μm) | Migration | Conductivity |
| Example 1 | A | A | 50 | 35 | 35 | A | D |
| Example 2 | B | B | 40 | 35 | 35 | A | C |
| Example 3 | C | C | 35 | 30 | 30 | A | B |
| Example 4 | D | D | 30 | 15 | 15 | A | A |
| Example 5 | D | D | 30 | 10 | 10 | A | A |
| Example 6 | E | E | 20 | 15 | 15 | B | A |
| Comparative | F | F | 80 | 35 | 35 | A | E |
| Example 1 | | | | | | | |
| Comparative | F | F | 80 | 15 | 15 | A | E |
| Example 2 | | | | | | | |
| Comparative | G | G | 53 | 15 | 15 | A | E |
| Example 3 | | | | | | | |
| Comparative | H | H | 18 | 15 | 15 | C | A |
| Example 4 | | | | | | | |

From the results shown in Table 2, it has been confirmed that in the touch sensor according to the embodiment of the present invention, a decrease in conductivity is suppressed and the occurrence of migration is suppressed in the peripheral wirings.

From the comparison between Examples 1 to 5, it has been found that in a case where the water contact angle of the substrate is 40° or less, the conductivity of the peripheral wirings is more excellent, in a case where the water contact angle of the substrate is 35° or less, the conductivity of the peripheral wirings is even more excellent, and in a case where the water contact angle of the substrate is 30° or less, the conductivity of the peripheral wirings is particularly excellent.

Further, from the comparison between Example 4 and Example 6, it has been confirmed that in a case where the water contact angle of the substrate is 25° or more, the performance of suppressing the migration between the peripheral wirings is more excellent.

### EXPLANATION OF REFERENCES

1: substrate
1A, 1B: surface
2: first conductive layer
3: second conductive layer
11, 21: touch detection electrode
12, 22: electrode connection terminal
13, 23: peripheral wiring
14, 24: external connection terminal
L: line width
MW: fine metal wire
MP: pattern
R1: detection region
R2: peripheral region
S: distance

What is claimed is:

1. A touch sensor comprising:
a substrate; and
a conductive layer formed on a surface of the substrate,
wherein the conductive layer has a touch detection electrode composed of a plurality of fine metal wires disposed in a mesh shape, an electrode connection terminal electrically connected to the touch detection electrode, and a peripheral wiring electrically connected to the electrode connection terminal,
the peripheral wiring has a to-be-plated layer and a metal plating layer covering the to-be-plated layer, and
the surface of the substrate has a water contact angle of 20° to 50°.

2. The touch sensor according to claim 1,
wherein the substrate contains a surfactant.

3. The touch sensor according to claim 2,
wherein the surfactant is a nonionic surfactant.

4. The touch sensor according to claim 3,
wherein the surface of the substrate has a water contact angle of 20° to 40°.

5. The touch sensor according to claim 1,
wherein a plurality of the peripheral wirings are present, and
in at least a part of a region where the peripheral wirings are disposed on the surface of the substrate, the peripheral wirings extend in a first direction, are arranged in a second direction perpendicular to the first direction, and a distance S between two peripheral wirings adjacent to each other is 30 μm or less.

6. The touch sensor according to claim 5,
wherein a plurality of the peripheral wirings are present, and
in at least a part of a region where the peripheral wirings are disposed on the surface of the substrate, the peripheral wirings extend in the first direction, are arranged in the second direction perpendicular to the first direction, and a distance S between two peripheral wirings adjacent to each other is 15 μm or less.

7. A touch panel comprising:
the touch sensor according to claim 1.
